(19) United States
(12) Patent Application Publication
(10) Pub. No.: US 2024/0078358 A1
(43) Pub. Date: Mar. 7, 2024

(54) TRACKING DEVICE, TRACKING METHOD, AND COMPUTER-READABLE NON-TRANSITORY STORAGE MEDIUM STORING TRACKING PROGRAM

(71) Applicant: DENSO CORPORATION, Kariya-city (JP)

(72) Inventor: Kentaro ARAI, Kariya-city (JP)

(21) Appl. No.: 18/506,646

(22) Filed: Nov. 10, 2023

Related U.S. Application Data
(63) Continuation of application No. PCT/JP2022/018842, filed on Apr. 26, 2022.

(30) Foreign Application Priority Data
May 14, 2021 (JP) 2021-082666

(51) Int. Cl. G06F 30/20; H03H 17/02

(52) U.S. Cl. CPC G06F 30/20; H03H 17/0257; G06F 2111/10

(57) ABSTRACT

By a tracking device, a tracking method, or a computer-readable non-transitory storage medium storing a tracking program, a state value of a mobile object is estimated to track the mobile object, the observation value of the mobile object observed at an observation time is acquired, a prediction state value is acquired, a true value of the state value at the observation time is estimated by nonlinear filtering.

### CROSS REFERENCE TO RELATED APPLICATIONS

The present application is a continuation application of International Patent Application No. PCT/JP2022/018842 filed on Apr. 26, 2022, which designated the U.S. and claims the benefit of priority from Japanese Patent Application No. 2021-082666 filed on May 14, 2021. The entire disclosures of all of the above applications are incorporated herein by reference.

### TECHNICAL FIELD

The present disclosure relates to a tracking technology for tracking a mobile object.

### BACKGROUND

A tracking technology for tracking a mobile object by estimating a state value of the mobile object in time series based on an observation value obtained by an external field sensor system is widely known. An example of tracking technology is a method of repeating state value estimation of a mobile object in time series by filtering using a Kalman filter.

### SUMMARY

By a tracking device, a tracking method, or a computer-readable non-transitory storage medium storing a tracking program, a state value of a mobile object is estimated to track the mobile object, the observation value of the mobile object observed at an observation time is acquired, a prediction state value is acquired, a true value of the state value at the observation time is estimated by nonlinear filtering.

### BRIEF DESCRIPTION OF DRAWINGS

FIG. 1 is a block diagram showing an overall configuration of a tracking device according to an embodiment.

FIG. 2 is a schematic diagram for illustrating an observation value and a rectangle model according to the embodiment.

FIG. 3 is a block diagram showing a functional configuration of the tracking device according to the embodiment.

FIG. 4 is a flowchart showing a tracking method according to the embodiment.

FIG. 5 is a schematic diagram for illustrating a prediction state value and a rectangle model according to the embodiment.

FIG. 6 is a flowchart showing an estimation process according to the embodiment.

FIG. 7 is a schematic diagram showing an weight setting example according to the embodiment.

FIG. 8 is a flowchart showing a subroutine of the weight setting according to the embodiment.

### DETAILED DESCRIPTION

The method proposed as the example is based on the premise that the entire mobile object is sufficiently observed from the external field sensor system. Therefore, when it is difficult to observe a part of the mobile object from the external field sensor system, the estimated state value deviates from the true value, and there is a possibility of deterioration in tracking accuracy.

One example of the present disclosure provides a tracking device that improves tracking accuracy for a mobile object. Another example of the present disclosure provides a tracking method that increases the tracking accuracy for the mobile object. Further, another example of the present disclosure provides a computer-readable non-transitory storage medium storing a tracking program that improves the tracking accuracy for the mobile object.

According to one example, a tracking device includes a processor and estimates a state value of a mobile object in time series based on an observation value from an external field sensor system to track the mobile object. The processor is configured to: acquire the observation value of the mobile object observed at an observation time; acquire a prediction state value by predicting the state value of the mobile object at the observation time; and estimate a true value of the state value at the observation time by nonlinear filtering using the observation value and the prediction state value at the observation time as a variable. Estimation of the true value includes: setting of a weighting factor for each of a plurality of vertices in a rectangle model obtained by modeling the mobile object according to a degree of visibility of each vertex from the external field sensor system; acquisition of an observation error at each vertex based on the observation value and the prediction state value at the observation time; and acquisition of a covariance of the observation error based on the weighting coefficient for each vertex.

According to another example, a tracking method causes a processor to estimate a state value of a mobile object in time series based on an observation value from an external field sensor system to track the mobile object. The method includes: acquiring the observation value of the mobile object observed at an observation time; acquiring a prediction state value by predicting the state value of the mobile object at the observation time; and estimating a true value of the state value at the observation time by nonlinear filtering using the observation value and the prediction state value at the observation time as a variable. Estimation of the true value includes: setting of a weighting factor for each of a plurality of vertices in a rectangle model obtained by modeling the mobile object according to a degree of visibility of each vertex from the external field sensor system; acquisition of an observation error at each vertex based on the observation value and the prediction state value at the observation time; and acquisition of a covariance of the observation error based on the weighting coefficient for each vertex.

Further, according to another example, a computer-readable non-transitory storage medium stores a tracking program comprising an instructions configured to, when executed by a processor, cause the processor to: estimate a state value of a mobile object in time series based on an observation value from an external field sensor system to track the mobile object; acquire the observation value of the mobile object observed at an observation time; acquire a prediction state value by predicting the state value of the mobile object at the observation time; and estimate a true value of the state value at the observation time by nonlinear filtering using the observation value and the prediction state value at the observation time as a variable. Estimation of the true value includes: setting of a weighting factor for each of a plurality of vertices in a rectangle model obtained by modeling the mobile object according to a degree of visibility of each vertex from the external field sensor system; acquisition of an observation error at each vertex based on the observation value and the prediction state value at the observation time; and acquisition of a covariance of the observation error based on the weighting coefficient for each vertex.

According to these first to third examples, the true value of the state value at the observation time is estimated by nonlinear filtering using the observation value and the prediction state value at the observation time as variables. At this time, the observation error at each vertex in the rectangle model obtained by modeling the mobile object is acquired based on the observation value and the prediction state value at the observation time, and the covariance of the observation error is acquired based on the weighting factor for each vertex. Therefore, according to the first to third modes in which the weighting factor is set according to the visibility from the external field sensor system for each vertex, the visual recognition degree can be reflected in the true value estimation of the state value. Therefore, it is possible to accurately estimate the true value of the state value and improve the accuracy of tracking the mobile object.

Hereinafter, an embodiment will be described with reference to the drawings.

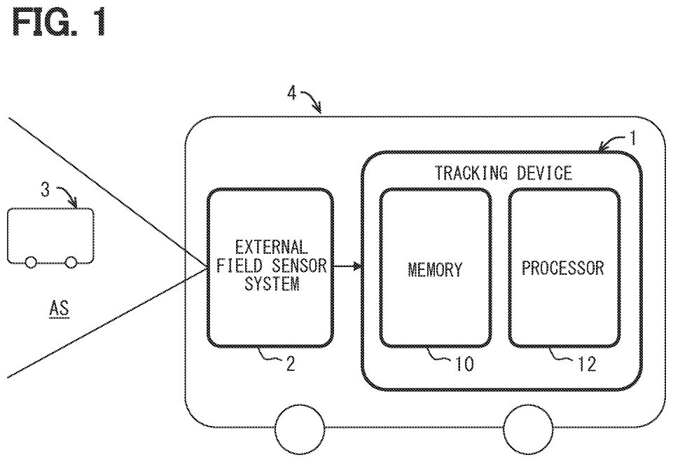

As shown in FIG. 1, a tracking device 1 according to the embodiment tracks a mobile object 3 by estimating a state value of the mobile object 3 in time series based on an observation value obtained by an external field sensor system 2. Therefore, the tracking device 1 is mounted on a vehicle 4 together with the external field sensor system 2.

The vehicle 4 is temporarily given an automated driving mode by switching from the manual driving mode, or constantly given the automated driving due to no execution of substantial switching. The automated driving mode may be achieved with an autonomous traveling control, such as conditional driving automation, advanced driving automation, or full driving automation, where the system in operation performs all driving tasks. The automated driving mode may be achieved with an advanced driving assistance control, such as driving assistance or partial driving automation, where an occupant performs some or all driving tasks. The automated driving mode may be achieved with either one or combination of the autonomous traveling control and the advanced driving assistance control or switching between the autonomous traveling control and the advanced driving assistance control.

The external field sensor system 2 observes the inside of a sensing area AS set in an external area of the vehicle 4, and outputs an observation value obtained in the sensing area AS. The external field sensor system 2 is, for example, LiDAR (Light Detection and Ranging/Laser Imaging Detection and Ranging), radar, camera, or fusion of at least two of these sensing devices.

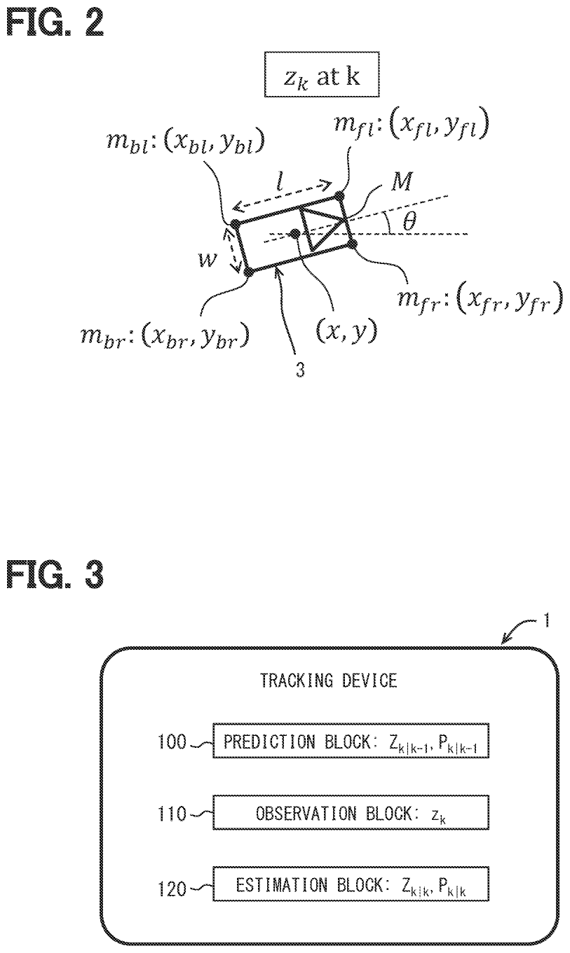

The external field sensor system 2 is controlled so as to repeat observations at predetermined tracking intervals. When the mobile object 3 exists within the sensing area AS, the external field sensor system 2 outputs an observation value zₖ at an observation time k for the mobile object 3 at each tracking cycle. Here, the observation value zₖ is defined by a first mathematical equation using physical quantities schematically shown in FIG. 2. In the first mathematical equation, x and y are a lateral center position and a vertical center position, respectively, of the mobile object 3 in an orthogonal coordinate system defined in the observation space. In the first mathematical equation, θ is an azimuth angle of the mobile object 3 with respect to a lateral direction in the orthogonal coordinate system defined in the observation space. In the first mathematical equation, l and w are a longitudinal length and a lateral width, respectively, of the mobile object 3 in the orthogonal coordinate system defined in the observation space.

zₖ=[x, y, θ, l, w]^{T} [First equation]

The tracking device 1 shown in FIG. 1 is connected to the external field sensor system 2 via at least one of, for example, a LAN (Local Area Network), wire harness, internal bus, wireless communication line, or the like. The tracking device 1 includes at least one dedicated computer. The dedicated computer that constitutes the tracking device 1 may be a driving control ECU (Electronic Control Unit) that implements driving control including an automated driving mode of the vehicle 4. The dedicated computer that constitutes the tracking device 1 may be a locator ECU that estimates a self state quantity of the vehicle 4. The dedicated computer that constitutes the tracking device 1 may be a navigation ECU that navigates a travel route of the vehicle 4. The dedicated computer constituting the tracking device 1 may be at least one external computer that constructs an external center or a mobile terminal capable of communicating with, for example, the vehicle 4.

The dedicated computer constituting the tracking device 1 has at least one memory 10 and at least one processor 12. The memory 10 is at least one type of non-transitory tangible storage medium, such as a semiconductor memory, a magnetic medium, and an optical medium, for non-transitory storage of computer readable programs, data, and the like, for example. The processor 12 includes, as a core, at least one of, for example, a CPU (Central Processing Unit), a GPU (Graphics Processing Unit), an RISC (Reduced Instruction Set Computer) CPU, and the like.

The processor 12 executes multiple instructions included in a tracking program stored in the memory 10. Thereby, the tracking device 1 constructs a plurality of functional blocks for tracking the mobile object 3. In such a manner, the tracking device 1 constructs the plurality of functional blocks by causing the processor 12 to execute the tracking program stored in the memory 10 for tracking the mobile object 3. As shown in FIG. 3, the functional blocks constructed by the tracking device 1 include a prediction block 100, an observation block 110, and an estimation block 120.

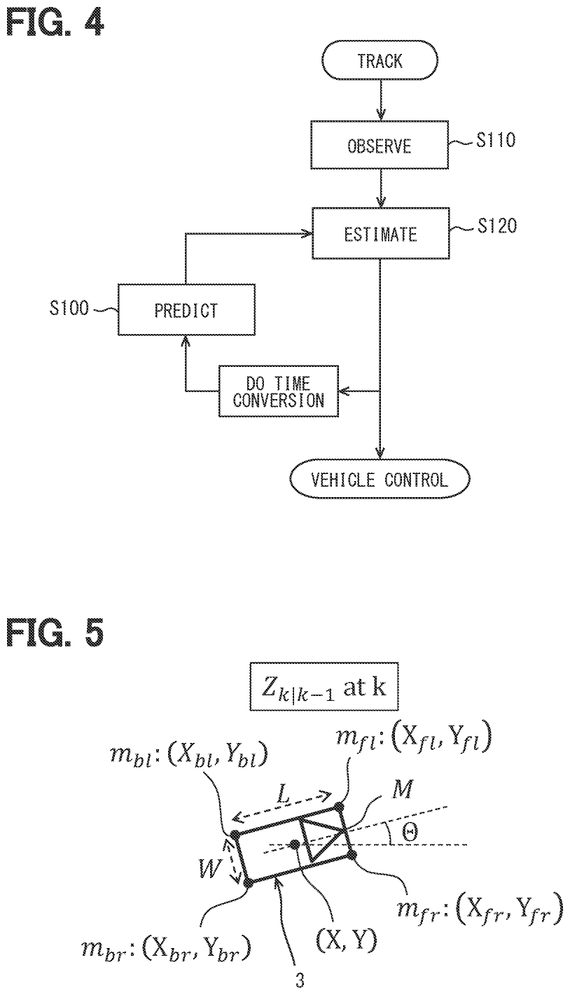

A flow of the tracking method in which the tracking device 1 tracks the mobile object 3 by the collaboration of the prediction block 100, the observation block 110, and the estimation block 120 will be described below with reference to FIG. 4. This flow is executed for each tracking cycle. Further, in this flow, “S” means the processes executed by instructions included in the tracking program.

In S100 of the tracking method, the prediction block 100 acquires a prediction state value Z_{k|k-1} and its error covariance Pk|k−1 shown in FIG. 3 and an error covariance P_{k|k-1} by predicting the state value of the mobile object 3 at the observation time k. Here, the prediction state value Z_{k|k-1} is defined by a second mathematical equation using physical quantities schematically shown in FIG. 5. In the second mathematical equation, X and Y are the lateral center position and the vertical center position, respectively, of the mobile object 3 in the orthogonal coordinate system defined in the observation space. In the second mathematical equation, Θ is the azimuth angle of the mobile object 3 with respect to the lateral direction in the orthogonal coordinate system defined in the observation space. In the second mathematical expression, L and W are a longitudinal length and a lateral width, respectively, of the mobile object 3 in the orthogonal coordinate system defined in the observation space. In the second mathematical equation, Vx and Vy (not shown in FIG. 5) are a lateral velocity and a vertically central velocity of the mobile object 3 in the orthogonal coordinate system defined in the observation space, respectively.

Z_{k|k-1}=[X, Y, Θ, L, W, Vx, Vy]^{T} [Second equation]

The prediction block 100 in S100 executes time conversion and time update calculation on an estimation state value Z_{k-1|k-1}, which is a state value estimated as a true value by the estimation block 120 at a past time k−1 before observation time k and its error covariance P_{k-1|k-1} to predictively acquire a prediction state value Z_{k|k-1}. At this time, the prediction state value z_{k|k-1} and the error covariance P_{k|k-1} are acquired using the estimation state value Z_{k-1|k-1} and the error covariance P_{k-1|k-1} at the past time k−1 by third to fifth equations. Here, Q in the fourth equation is a covariance matrix of system noise (process noise).

$${Z}_{k \vert k - 1} = {FZ}_{k - 1 \vert k - 1} \qquad [ Third equation ]$$

$${P}_{k \vert k - 1} = {FP}_{k - 1 \vert k - 1} {F}^{T} + Q \qquad [ Fourth equation ]$$

$$F = [ \begin{matrix}1 & 0 & 0 & 0 & 0 & 1 & 0 \\ 0 & 1 & 0 & 0 & 0 & 0 & 1 \\ 0 & 0 & 1 & 0 & 0 & 0 & 0 \\ 0 & 0 & 0 & 1 & 0 & 0 & 0 \\ 0 & 0 & 0 & 0 & 1 & 0 & 0 \\ 0 & 0 & 0 & 0 & 0 & 1 & 0 \\ 0 & 0 & 0 & 0 & 0 & 0 & 1\end{matrix} ] \qquad [ Fifth equation ]$$

In S110 of the tracking method shown in FIG. 4, the observation block 110 acquires, from the external field sensor system 2, the observation value zₖ of the mobile object 3 at the observation time k shown in FIG. 3. Acquisition of the observation value zₖ in S110 may be executed as the observation value zₖ is output from the external field sensor system 2, or may be executed after the output observed value zₖ is once buffered in the memory 10. Further, the acquisition of the observation value zₖ in S110 may be executed in parallel (that is, simultaneously) with the acquisition of the prediction state value Z_{k|k-1} in S100, or may be executed, or the execution timings of the acquisition of the observation value zₖ and the observation value Z_{k|k-1} may be different from each other.

In S120 of the tracking method shown in FIG. 4, the estimation block 120 estimates the state value of the mobile object 3 at the observation time k to obtain the estimation state value Z_{k|k} as the true value of the state value shown in FIG. 3 and the error covariance P_{k|k}. At this time, the estimation state value Z_{k|k} and the error covariance P_{k|k} are acquired by nonlinear filtering that performs an observation update calculation using the observation value zₖ and the prediction state value Z_{k|k-1} at the observation time k as variables.

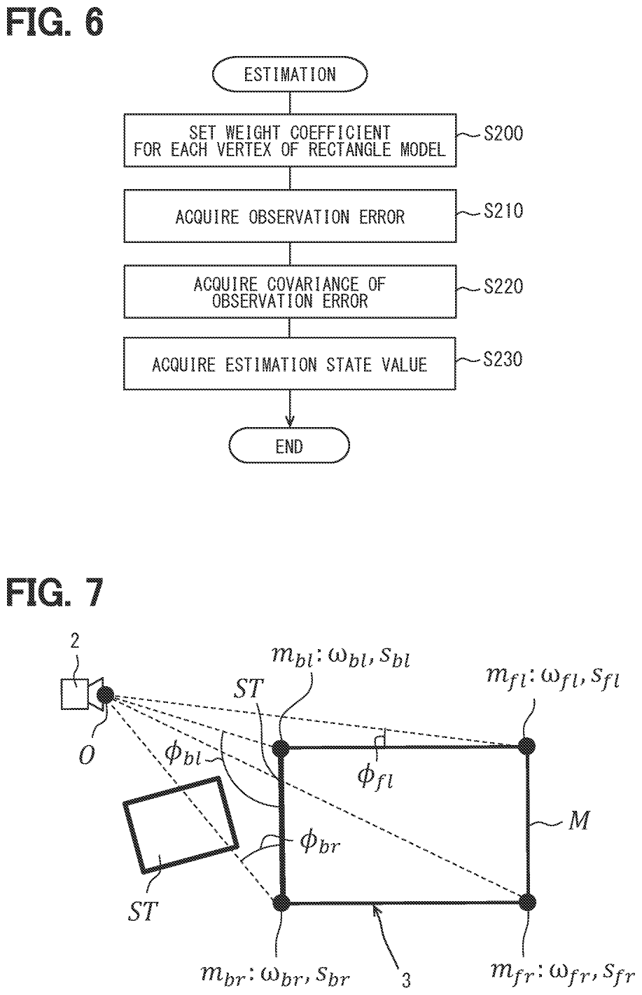

Specifically, the estimation block 120 in S120 executes the estimation process shown in FIG. 6. In S200 of the estimation process, as shown in FIGS. 2, 5, and 7, the estimation block 120 sets weight coefficients s_{fl}, s_{bl}, s_{fr}, s_{br} for vertices m_{fl}, m_{bl}, m_{fr}, m_{br} of a rectangle model M obtained by schematically modeling the mobile object 3 in the rectangle manner.

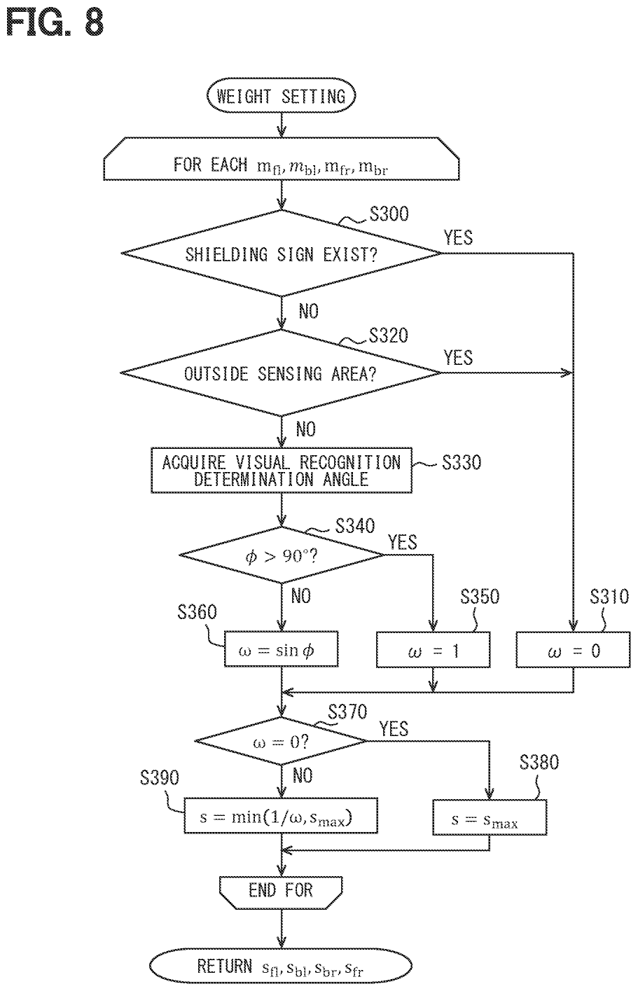

At this time, the estimation block 120 in S200 executes the weight setting subroutine shown in FIG. 8 so as to set the weight coefficients s_{fl}, s_{bl}, s_{fr}, s_{br} in accordance with the visual recognition degrees ω_{fl}, ω_{bl}, ω_{fr}, ω_{br} for each of the vertices m_{fl}, m_{bl}, m_{fr}, m_{br} from the external field sensor system 2. The subroutine is repeatedly executed the number of times corresponding to the number of vertices m_{fl}, m_{bl}, m_{fr}, and m_{br}. Therefore, among the vertices m_{fl}, m_{bl}, m_{fr}, and m_{br}, the vertex to be executed each time in this subroutine is called a target vertex m. In the description of this subroutine, except for some examples based on FIG. 7, the notations fl, bl, fr, and br, which are suffixes indicated by subscripts to various variables, indicate left front, left back (left rear), right front, and right back (right rear) of the mobile object 3, respectively, and are omitted, for example, as shown by the target vertex m.

In S300 of the weight setting subroutine shown in FIG. 8, the estimation block 120 determines whether a shielding target ST shown in FIG. 7 exists between an observation origin O of the external field sensor system 2 and the target vertex m. Here, as illustrated in FIG. 7 regarding the right rear vertex m_{br}, the shielding target ST is placed on a line segment connecting the observation origin O and the target vertex m (m_{br} in the figure), and may exist separately from the mobile object 3. The shielding target ST may be a component of the mobile object 3, and the component corresponds to one side of the rectangle model M existing on the line segment connecting the observation origin O and the target vertex m (m_{fr} in the figure), as illustrated in FIG. 7 regarding the right front vertex m_{fr}. The observation origin O may be a sensing origin set in a single sensor device that constitutes the external field sensor system 2, or may be the spatial origin assumed in the observation space by fusion of a plurality of sensor devices that constitute the external field sensor system 2.

As shown in FIG. 8, when it is determined in S300 that the shielding target ST exists, the weight setting subroutine proceeds to S310, whereby the estimation block 120 sets the visual recognition degree ω to the lowest value. Here, in the example of FIG. 7, the visual recognition degree levels ω_{br} and ω_{fr} of the right rear vertex m_{br} and the right front vertex m_{fr} hidden by the shielding target ST are set to “0” as the lowest value.

As shown in FIG. 8, when it is determined in S300 that the shielding target ST does not exist, the weight setting subroutine proceeds to S320. The estimation block 120 determines whether the target vertex m is outside the sensing area AS of the external field sensor system 2. As a result, when it is determined that the target vertex m exists outside the sensing area AS, the weight setting subroutine proceeds to S310, and the estimation block 120 sets the visual recognition degree ω to the lowest value. The sensing area AS may be a viewing angle set for a single sensor device that constitutes the external field sensor system 2, or may be an overlapping area between the viewing angles of a plurality of sensor devices that constitute the external field sensor system 2.

When it is determined in S320 that the target vertex m does not exist outside the sensing area AS, the weight setting subroutine proceeds to S330, and the estimation block 120 acquires a visual recognition determination angle φ. The visual recognition degree may be also referred to as a visibility. Here, as shown in FIG. 7, the visual recognition determination angle φ is the smallest angle among angles between two sides connected to the target vertex m and a line segment connecting the observation origin O and the target vertex m. Here, the minimum angle φ_{bl} in the illustration of FIG. 7 regarding the left rear vertex m_{bl} and the minimum angle φ_{fl} in the illustration of FIG. 7 regarding the left front vertex m_{fl} respectively correspond to the visual recognition determination angle φ.

As shown in FIG. 8, in S340 of the weight setting subroutine following S330, the estimation block 120 determines whether the visual recognition determination angle φ exceeds 90 degrees. As a result, when the visual recognition determination angle φ exceeds 90 degrees, the weight setting subroutine proceeds to S350, and the estimation block 120 sets the visibility ω to the maximum value. On the other hand, when the visually recognition determination angle φ is 90 degrees or less, the weight setting subroutine proceeds to S360, and the estimation block 120 sets the visibility ω that is equal to or more than the minimum value and equal to or less than the maximum value by a sixth equation. Here, in the example of FIG. 7 regarding the left rear vertex m_{bl}, the visual recognition degree ω_{bl} is set to “1” as the maximum value, due to the visually recognition determination angle φ_{bl} exceeding 90 degrees. On the other hand, in the example of FIG. 7 regarding the left front vertex m_{fl}, the visibility ω_{fl} is set to the calculation value (sin φ_{fl}) in a sixth equation due to the visual recognition determination angle φ_{fl} of 90 degrees or less.

ω=sin φ [Sixth equation]

As shown in FIG. 8, in S370 of the weight setting subroutine following S310, S350, and S360, the estimation block 120 determines whether the visual recognition degree ω is “0” as the minimum value. As a result, when the visual recognition degree ω is 0, the weight setting subroutine proceeds to S380, and the estimation block 120 sets the weight coefficient s to the maximum value sₘₐₓ. On the other hand, when the visibility ω is not 0, the weight setting subroutine proceeds to S390, and the estimation block 120 sets the smaller value of the reciprocal of the visual recognition degree ω (1/ω) and the maximum value sₘₐₓ to the weight coefficient s. In particular, when the weighting coefficient s is set to the reciprocal of the visual recognition degree ω, the weighting coefficient s is set smaller for the vertex m with a higher visibility ω.

Here, in the example of FIG. 7 regarding the right rear vertex m_{br} and the right front vertex m_{fr} hidden by the shielding target ST, the weighting coefficient s is set to the maximum value sₘₐₓ. On the other hand, in the example of FIG. 7 regarding the left rear vertex m_{bl} and the left front vertex m_{fl}, of the maximum value as the visual recognition degree ω or the reciprocal of the calculation value in the sixth equation (1 or 1/sin φ_{fl}) and the maximum value sₘₐₓ, the smaller value is set. Note that the maximum value sₘₐₓ of the weighting coefficient s is defined to be a guard value larger than “1”, which can prevent a covariance S_{new} of an observation error e_{new}, which will be described later, from becoming infinite due to the nonlinear filtering.

When the weight setting subroutine of S200 is completed for all vertices m_{fl}, m_{bl}, m_{fr}, and m_{br}, the estimation process proceeds to S210 as shown in FIG. 6. In S210, the estimation block 120 obtains the observation error e_{new} at each vertex m_{fl}, m_{bl}, m_{fr}, and m_{br} based on the observation value zₖ at the observation time k and the prediction state value Z_{k|k-1}.

At this time, the estimation block 120 in S210 converts physical quantities x, y, θ, l, w of the observation value zₖ into an expansion observation value z_{new} according to expansion of the vertices m_{fl}, m_{bl}, m_{fr}, m_{br} of the rectangle model, by a nonlinear function h_{new} of a seventh equation and matrix conversion functions of eighth to eleventh equations. Here, x_{fl}, x_{bl}, x_{fr}, and x_{br} in the eighth to eleventh equations are position coordinates that constitute the expansion observation value z_{new}, which is obtained by expanding the horizontal position x of the observation value zₖ to each vertex m_{fl}, m_{bl}, m_{fr}, and m_{br} as shown in FIG. 2. Further, y_{fl}, y_{bl}, y_{fr}, and y_{br} in the eighth to eleventh equations are position coordinates that constitute the expansion observation value z_{new}, which is obtained by expanding the vertical position y of the observation value zₖ to each vertex m_{fl}, m_{bl}, m_{fr}, and m_{br} as shown in FIG. 2.

$${z}_{n e w} = {h}_{n e w} ( x , y , θ , l , w ) = {[ {x}_{fl} , {y}_{fl} , {x}_{b l} , {y}_{b l} , {x}_{br} , {y}_{br} , {x}_{fr} , {y}_{fr} ]}^{T} \qquad [ Seventh equation ]$$

$$[ \begin{matrix}{x}_{fl} \\ {y}_{fl}\end{matrix} ] = [ \begin{matrix}x \\ y\end{matrix} ] + [ \begin{matrix}cos θ & - s in θ \\ sin θ & cos θ\end{matrix} ] [ \begin{matrix}l / 2 \\ w / 2\end{matrix} ] \qquad [ Eighth equation ]$$

$$[ \begin{matrix}{x}_{bl} \\ {y}_{bl}\end{matrix} ] = [ \begin{matrix}x \\ y\end{matrix} ] + [ \begin{matrix}cos θ & - s in θ \\ sin θ & cos θ\end{matrix} ] [ \begin{matrix}- l / 2 \\ w / 2\end{matrix} ] \qquad [ Ninth equation ]$$

$$[ \begin{matrix}{x}_{br} \\ {y}_{br}\end{matrix} ] = [ \begin{matrix}x \\ y\end{matrix} ] + [ \begin{matrix}cos θ & - s in θ \\ sin θ & cos θ\end{matrix} ] [ \begin{matrix}- l / 2 \\ - w / 2\end{matrix} ] \qquad [ Tenth equation ]$$

$$[ \begin{matrix}{x}_{fr} \\ {y}_{fr}\end{matrix} ] = [ \begin{matrix}x \\ y\end{matrix} ] + [ \begin{matrix}cos θ & - s in θ \\ sin θ & cos θ\end{matrix} ] [ \begin{matrix}l / 2 \\ - w / 2\end{matrix} ] \qquad [ Eleventh equation ]$$

The estimation block 120 in S210 converts physical quantities X, Y, θ, L, W of the prediction state value Z_{k|k-1} into an expansion observation value Z_{new} according to expansion of the vertices m_{fl}, m_{bl}, m_{fr}, m_{br} of the rectangle model M, by the nonlinear function h_{new} of a twelfth equation and matrix conversion functions of thirteenth to sixteenth equations. Here, X_{fl}, X_{bl}, X_{fr}, and X_{br} in the thirteenth to sixteenth equations are position coordinates that constitute the expansion state value Z_{new}, which is obtained by expanding the horizontal position X of the prediction state value Z_{k|k-1} to each vertex m_{fl}, m_{bl}, m_{fr}, and m_{br} as shown in FIG. 5. Further, Y_{fl}, Y_{bl}, Y_{fr}, and Y_{br} in the thirteenth to sixteenth equations are position coordinates that constitute the expansion state value Z_{new}, which is obtained by expanding the vertical position Y of the prediction state value Z_{k|k-1} to each vertex m_{fl}, m_{bl}, m_{fr}, and m_{br} as shown in FIG. 5.

$${z}_{n e w} = {h}_{n e w} ( X , Y , Θ , L , W ) = {[ {X}_{fl} , {Y}_{fl} , {X}_{b l} , {Y}_{b l} , {X}_{br} , {Y}_{br} , {X}_{fr} , {Y}_{fr} ]}^{T} \qquad [ Twelfth equation ]$$

$$[ \begin{matrix}{X}_{fl} \\ {Y}_{fl}\end{matrix} ] = [ \begin{matrix}X \\ Y\end{matrix} ] + [ \begin{matrix}cos Θ & - s in Θ \\ sin Θ & cos Θ\end{matrix} ] [ \begin{matrix}L / 2 \\ W / 2\end{matrix} ] \qquad [ Thirteenth equation ]$$

$$[ \begin{matrix}{X}_{b l} \\ {Y}_{b l}\end{matrix} ] = [ \begin{matrix}X \\ Y\end{matrix} ] + [ \begin{matrix}cos Θ & - s in Θ \\ sin Θ & cos Θ\end{matrix} ] [ \begin{matrix}- L / 2 \\ W / 2\end{matrix} ] \qquad [ Fourteenth equation ]$$

$$[ \begin{matrix}{X}_{br} \\ {Y}_{b τ}\end{matrix} ] = [ \begin{matrix}X \\ Y\end{matrix} ] + [ \begin{matrix}cos Θ & - s in Θ \\ sin Θ & cos Θ\end{matrix} ] [ \begin{matrix}- L / 2 \\ - W / 2\end{matrix} ] \qquad [ Fifteenth equation ]$$

$$[ \begin{matrix}{X}_{fr} \\ {Y}_{fr}\end{matrix} ] = [ \begin{matrix}X \\ Y\end{matrix} ] + [ \begin{matrix}cos Θ & - s in Θ \\ sin Θ & cos Θ\end{matrix} ] [ \begin{matrix}L / 2 \\ - W / 2\end{matrix} ] \qquad [ Sixteenth equation ]$$

In the estimation block 120 in S210, the observation error e_{new} is obtained as shown in FIG. 6 by a seventeenth equation using the expansion observation value z_{new} and the expansion state value Z_{new} that are converted in such a manner.

e_{new}=z_{new}−Z_{new} [Seventeenth equation]

In S220 of the estimation process following S210, the estimation block 120 acquires the covariance S_{new} of the observation error e_{new} based on the weighting coefficients s_{fl}, s_{bl}, s_{fr}, and s_{br} of the vertices m_{fl}, m_{bl}, m_{fr}, and m_{br}. At this time, the estimation block 120 acquires an 8×8 covariance matrix R_{new} of the observation error e_{new} weighted for each vertex m_{fl}, m_{bl}, m_{fr}, and m_{br} by an eighteenth equation using the weighting coefficients s_{fl}, s_{bl}, s_{fr}, and s_{br}. Here, R′ in the eighteenth equation is a covariance matrix for horizontal position and vertical position, and is an adjustment parameter that can be adjusted by presetting. Furthermore, the estimation block 120 acquires the partial differential matrix (Jacobian) H_{new} for the nonlinear function of the twelfth equation by a nineteenth equation. Thus, the estimation block 120 acquires a covariance S_{new} of the observation error e_{new} by a twentieth equation using the error covariance P_{k|k-1} of the prediction state value Z_{k|k-1} and the covariance matrix R_{new} and the partial differential matrix H_{new}.

$${R}_{n e w} = diag ( {s}_{fl} {R}^{′} , {s}_{b l} , {R}^{′} , {s}_{br} {R}^{′} , {s}_{fr} {R}^{′} ) \qquad [ Eighteenth equation ]$$

$${H}_{n e w} = \frac{\partial {h}_{n e w} ( X , Y , Θ , L , W )}{\partial Z} {\vert}_{Z = {Z}_{k \vert k - 1}} \qquad [ Nineteenth equation ]$$

$${S}_{n e w} = {R}_{n e w} + {H}_{n e w} {P}_{k \vert k - 1} {H}_{n e w}^{T} \qquad [ Twentieth equation ]$$

In S230 of the estimation process following S220, the estimation block 120 performs nonlinear filtering using an extended Kalman filter to acquire the estimation state value Z_{k|k} as the true value obtained by updating the prediction state value Z_{k|k-1}, and the error covariance P_{k|k}. Then, the estimation block 120 acquires a Kalman gain K_{new} of the extended Kalman filter by a twenty-first equation using the covariance S_{new} of the observation error e_{new} and the partial differential matrix H_{new} and the error covariance P_{k|k-1} of the prediction state value Z_{k|k-1}. As a result, in the estimation block 120, the estimation state value Z_{k|k} is acquired by a twenty-second equation using the prediction state value Z_{k|k-1} along with the Kalman gain K_{new} and observation error e_{new}. Further, in the estimation block 120, the error covariance P_{k|k} of the estimation state value Z_{k|k} is acquired by a twenty-third equation using, with the Kalman gain K_{new} and the partial differential matrix H_{new}, the error covariance P_{k|k-1} of the prediction state value Z_{k|k-1}. Here, I in the twenty-third equation is a unit matrix.

K_{new}=P_{k|k-1}H_{new}^{T}S_{new}⁻¹ [Twenty-first equation]

Z_{k|k}=Z_{k|k-1}+K_{new}e_{new} [Twenty-second equation]

P_{k|k}=(I−K_{new}H_{new})P_{k|k-1} [Twenty-third equation]

As shown in FIG. 4, the estimation state value Z_{k|k} at the latest observation time k acquired by the tracking method in the current tracking cycle is output to the driving control ECU, and thereby is used for a driving control including the automated driving mode of the vehicle 4. Also, the estimation state value Z_{k|k} at the observation time k acquired by the tracking method in the current tracking cycle is used as the estimation state value Z_{k-1|k-1} at the past time k−1 in the tracking method at the next tracking method cycle and used for prediction in S100 by the prediction block 100.

### Operation Effects

The functions and effects in the present embodiment described above will be explained below. In the description of the effects, notations fl, bl, fr, and fr indicating the left front, left rear, right front, and right rear of the mobile object 3 are suffixes indicated by subscripts for various variables and are omitted.

According to this embodiment, the true value of the state value at observation time k is estimated by nonlinear filtering using the observation value zk at observation time k and the prediction state value Z_{k|k-1} as variables. At this time, the observation error e_{new} at each vertex m in the rectangle model M obtained modeling the mobile object 3 is obtained based on the observation value zk and the prediction state value Z_{k|k-1} at the observation time k. Together with this, the covariance S_{new} of the observation error e_{new} is acquired based on the weighting coefficient s for each vertex m. Therefore, according to the present embodiment, in which the weighting coefficient s is set for each vertex according to the visual recognition degree ω from the external field sensor system 2, the visibility ω can be reflected in the true value estimation of the state value. Therefore, it is possible to accurately estimate the estimation state value Z_{k|k}, which is the true value of the state value, and improve the accuracy of tracking the mobile object 3.

According to the present embodiment, the weighting coefficient s is set smaller for the vertex m with the higher visual recognition degree ω. According to this, with regard to the vertex m with the high visual recognition degree ω from the external field sensor system 2, the matrix component of the covariance S_{new} becomes small, so that the degree of contribution to the true value estimation of the state value increases. Therefore, by estimating the estimation state value Z_{k|k} as an accurate true value reflecting the visual recognition degree ω from the external field sensor system 2, it is possible to improve the tracking accuracy for the mobile object 3.

According to the present embodiment, the weighting coefficient s is set to the maximum value sₘₐₓ for the vertex m that sandwiches the shielding target ST with the external field sensor system 2. According to this, with respect to the vertex m for which the visual recognition degree ω from the external field sensor system 2 is assumed to be substantially zero because it is hidden by the shielding target ST, the matrix component of the covariance S_{new} becomes large, so that the contribution to the true value estimation of the state value decreases. Therefore, by estimating the estimation state value Z_{k|k} as an accurate true value reflecting the visual recognition degree ω from the external field sensor system 2, it is possible to improve the tracking accuracy for the mobile object 3.

According to the present embodiment, the weighting coefficient s is set to the maximum value sₘₐₓ for the vertex m existing outside the sensing area AS of the external field sensor system 2. According to this, with respect to the vertex m for which the visual recognition degree ω from the external field sensor system 2 is assumed to be substantially zero because it is outside the sensing area AS, the matrix component of the covariance S_{new} becomes large, so that the contribution to the true value estimation of the state value decreases. Therefore, by estimating the estimation state value Z_{k|k} as an accurate true value reflecting the visual recognition degree ω from the external field sensor system 2, it is possible to improve the tracking accuracy for the mobile object 3.

### Other Embodiments

Although one embodiment has been described, the present disclosure should not be limited to the above embodiment and may be applied to various other embodiments within the scope of the present disclosure.

The dedicated computer of the tracking device 1 of the modification example may include at least one of a digital circuit and an analog circuit as a processor. In particular, the digital circuit is at least one type of, for example, an ASIC (Application Specific Integrated Circuit), a FPGA (Field Programmable Gate Array), an SOC (System on a Chip), a PGA (Programmable Gate Array), a CPLD (Complex Programmable Logic Device), and the like. Such a digital circuit may include a memory in which a program is stored.

The tracking device, tracking method, and tracking program according to modifications may be applied to other than vehicles. In this case, the tracking device that is applied to something other than the vehicle may be mounted or installed on the same application target as the external field sensor system 2, or may be mounted or installed on a different application target from the external field sensor system 2.

1. A tracking device that comprises a processor and estimates a state value of a mobile object in time series based on an observation value from an external field sensor system to track the mobile object, wherein
the processor is configured to:
acquire the observation value of the mobile object observed at an observation time;
acquire a prediction state value by predicting the state value of the mobile object at the observation time; and
estimate a true value of the state value at the observation time by nonlinear filtering using the observation value and the prediction state value at the observation time as a variable, and
estimation of the true value includes:
setting of a weighting factor for each of a plurality of vertices in a rectangle model obtained by modeling the mobile object according to a degree of visibility of each vertex from the external field sensor system;
acquisition of an observation error at each vertex based on the observation value and the prediction state value at the observation time; and
acquisition of a covariance of the observation error based on the weighting coefficient for each vertex.

2. The tracking device according to claim 1, wherein
the setting of the weighting coefficient includes setting the weighting coefficient to be smaller for a vertex having a higher visual recognition degree.

3. The tracking device according to claim 1, wherein
the setting of the weighting coefficient includes setting the weighting coefficient to a maximum value for a vertex that sandwiches a shielding target with the external field sensor system.

4. The tracking device according to claim 1, wherein
the setting of the weighting coefficient includes setting the weighting coefficient to a maximum value for a vertex existing outside a sensing area of the external field sensor system.

5. The tracking device according to claim 1, wherein
the acquisition of the prediction state value includes acquisition of the prediction state value at the observation time based on the true value estimated at a past time prior to the observation time.

6. The tracking device according to claim 1, wherein
the estimation of the true value includes acquisition of the true value obtained by updating the prediction state value by the nonlinear filtering using an extended Kalman filter.

7. A tracking method causing a processor to estimate a state value of a mobile object in time series based on an observation value from an external field sensor system to track the mobile object, the method comprising:
acquiring the observation value of the mobile object observed at an observation time;
acquiring a prediction state value by predicting the state value of the mobile object at the observation time; and
estimating a true value of the state value at the observation time by nonlinear filtering using the observation value and the prediction state value at the observation time as a variable,
wherein
estimation of the true value includes:
setting of a weighting factor for each of a plurality of vertices in a rectangle model obtained by modeling the mobile object according to a degree of visibility of each vertex from the external field sensor system;
acquisition of an observation error at each vertex based on the observation value and the prediction state value at the observation time; and
acquisition of a covariance of the observation error based on the weighting coefficient for each vertex.

8. A computer-readable non-transitory storage medium storing a tracking program comprising an instructions configured to, when executed by a processor, cause the processor to:
estimate a state value of a mobile object in time series based on an observation value from an external field sensor system to track the mobile object;
acquire the observation value of the mobile object observed at an observation time;
acquire a prediction state value by predicting the state value of the mobile object at the observation time; and
estimate a true value of the state value at the observation time by nonlinear filtering using the observation value and the prediction state value at the observation time as a variable,
wherein
estimation of the true value includes:
setting of a weighting factor for each of a plurality of vertices in a rectangle model obtained by modeling the mobile object according to a degree of visibility of each vertex from the external field sensor system;
acquisition of an observation error at each vertex based on the observation value and the prediction state value at the observation time; and
acquisition of a covariance of the observation error based on the weighting coefficient for each vertex.
